(19) United States
(12) Patent Application Publication
(10) Pub. No.: US 2015/0368400 A1
(43) Pub. Date: Dec. 24, 2015

(54) PROCESS FOR THE PRODUCTION OF POLYAMIDES

(71) Applicant: DSM IP ASSETS B.V., Heerlen (NL)

(72) Inventors: Rudy RULKENS, Echt (NL); Renier Henricus Maria KIERKELS, Echt (NL); Theo Joseph CUYPERS, Echt (NL); Geert Adelina Rudolf VANDEN POEL, Echt (NL); Eric GROLMAN, Echt (NL)

(21) Appl. No.: 14/763,606

(22) PCT Filed: Jan. 30, 2014
(86) PCT No.: PCT/EP2014/051802

§ 371 Date: Jul. 27, 2015

(30) Foreign Application Priority Data
Jan. 30, 2013 (EP) PCT/EP2013/051813

(51) Int. Cl. C08G 69/36

(52) U.S. Cl. CPC C08G 69/36

(57) ABSTRACT

The invention relates to process for the production of a PA-MXDT/ZT polyamide comprising the following steps: (i) providing a solid MXDT/ZT salt, wherein MXD is meta-xylylenediamine, T is terephthalic acid, Z is a linear aliphatic diamine having from 2 to 12 carbon atoms and wherein the amount of Z is from 0 to 40 mole % with respect to the total of the amount of MXD and Z units in the polymer, (ii) solid state polymerizing the MXDT/ZT salt to obtain the polyamide, wherein the solid state polymerization is carried out at least partly under a diamine atmosphere. The invention further relates to a PA-MXDT/ZT polyamide, wherein the polymer has a glass transition temperature fulfilling the following relation: Tg>226−475*Y, wherein Y is the weight ratio g/g of all CH₂ groups in the polymer with respect to the total weight of the polyamide.

The invention relates to a process for the production of a PA-MXDT/ZT polyamide, wherein MXD is meta-xylylenediamine, T is terephthalic acid, Z is a linear aliphatic diamine having from 2 to 12 carbon atoms. The invention further relates to a PA-MXDT/ZT polyamide.

A process for the production of an alike polyamide is known from US2009/0012229 A1. US2009/0012229 A1 describes a process, wherein an aqueous solution of terephthalic acid, isophthalic acid, hexamethylene diamine and an aromatic diamine is heated under elevated pressure in an autoclave to between 280 and 330° C. and then prepolymer and vapours are separated and the prepolymer is passed into a polycondensation zone and polycondensed. Although one of the objects of US2009/0012229 A1 was to provide a semi-crystalline semi-aromatic copolyamide moulding composition with a high glass transition temperature, the obtained glass transition temperatures (Tg) between 125 and 138° C. are still relatively low. A higher Tg results in an improved barrier for gasses. Another advantage of a higher Tg is that a smaller difference between melting point and glass transition promotes the manufacturing of transparent materials.

An object of the present invention is to provide a process for the production of polyamides that result in polyamides with higher Tg values.

According to the invention, this object is reached by the features of claim 1.

As a result of the process according to the invention polyamides can be prepared with glass transition temperatures well above those that would be obtained by known processes for the production of polyamides.

The first step of the process of the invention is providing a solid MXDT/ZT salt, wherein MXD is meta-xylylenediamine, T is terephthalic acid, Z is a linear aliphatic diamine having from 2 to 12 carbon atoms and wherein the amount of Z is from 0 to 40 mole % with respect to the total of the amount of MXD and Z units in the polymer. The molar ratio MXDT units and ZT units is in the range from 60/40 to 100/0. Providing a solid MXDT/ZT salt can be done by any known process in the art e.g. a process wherein the MXDT/ZT salt is prepared from diamines MXD and Z in an aqueous solution.

With the expression “from x to y” wherein x and y are numerical values, as for example in “from 2 to 12 carbon atoms” and “from 0 to 40 mole %” is herein meant that the values x and y are included. Thus “from x to y” shall be read as “from x up to and including y”.

Preferably the solid MXDT/ZT salt is provided by a process wherein the MXDT/ZT salt is prepared by dosing of liquid diamines MXD and Z to an agitated powder of terephthalic acid. An advantage of this process is that the isolation of the resulting salt from the solvent or dispersant are omitted, thereby omitting costs of solvent handling and recycling, and saving on energy costs. The salt obtained in step (i) is already a powder, thus there is no need for crushing and grinding the salt as in the case salt is prepared from solution. The process can be carried out under very mild conditions. There is no need to work under high pressure, or in an atmosphere of superheated steam, or in a complex controlled diamine atmosphere. The process can be performed with a nitrogen gas purge, resulting in faster removal of water resulting from the neutralization reaction, thereby reducing the risk of caking of the reaction mixture.

A second step comprises a direct solid-state polymerization, here also referred to as DSSP, of the MXDT/ZT salt to obtain the polyamide, wherein the solid-state polymerization is carried out at least partly under a diamine atmosphere.

A diamine atmosphere can be obtained by the addition of small amounts of diamines at the beginning or during the second step. Addition of too high amounts of diamines should be avoided, as this will lead to a polymer having a too low molecular weight due to high amine end group content. According to the present invention, the diamine atmosphere is provided such as to obtain a polymer having amine end groups in a concentration [NH₂] and carboxylic acid end groups in a concentration [COOH], wherein the difference in concentrations [COOH]-[NH₂] is at most 150 meq/kg the concentration of the end groups being measured by 1H-NMR as recited hereafter. A diamine atmosphere can also be provided by the application of a separation column for the separation of water and diamines, allowing the diamines to return into the reaction vessel as a liquid during the polymerization. Another way to provide a diamine atmosphere during at least part of the second step is to avoid the diversion of the diamines formed in the second step e.g. by a low nitrogen current or at a low pressure by an applied vacuum. For small-scale experiments, carried out in a 0.05 ml reactor, typically made of aluminum, a diamine atmosphere is obtained by evaporation of small amounts of diamine from the salt and keeping them in the reactor, which is situated in an inert atmospheric surrounding with a gas stream passing by the reactor to remove evaporating gasses, by limiting the diameter of the hole in the reactor lid with typically from 0.02 to 0.1 mm and preferably about 0.05 mm. Suitably such reactor is a TGA or DSC crucible, being heated in a TGA, DSC or combined TGA/DSC instrument.

The direct solid-state polymerization in the second step can be divided in two sub-steps In the first sub-step the solid MXDT/ZT salt can be heated to a first condensation temperature (Tc1) thereby condensing the salt in solid state to produce a solid polyamide prepolymer, wherein Tc1 is below the melting temperature of the said salt (Tm-salt). This first condensation sub-step is considered to be complete if all salt is converted into a prepolymer, or nearly so. In case of complete conversion, no residual melting of the salt is observable. The absence of a melting peak of the salt can be verified by means of DSC applying the DSC method and conditions as described above.

In order to increase the molecular weight of the prepolymer, the first sub-step can be followed by a second sub-step, which comprises condensing the solid polyamide prepolymer at a second condensation temperature (Tc2) below the melting temperature of the polyamide prepolymer to produce a polyamide copolymer of a higher degree of polymerization.

The condensation sub-steps may be carried out in any manner suitable for conventional DSSP processes, for example, in a static bed reactor or in an agitated bed reactor. The use of an agitated bed reactor, such as a rotating vessel or a mechanically stirred reactor, wherein the solid MXDT/ZT salt and solid copolymer are agitated thereby creating and maintaining a flowable powder, contribute to the result that the polymer granulate material obtained by the process contributes to the formation of a non-sticky powder material. For the second condensation sub-step a static bed might be an economically better alternative.

During the condensation sub-steps, suitably an inert gas purge is applied to remove any water initially present in the MXDT/ZT salt, and more importantly to remove water produced by the condensation reaction. Alternatively, partial water vapour pressure is reduced, by applying a vacuum, or a combination of an inert gas purge and a reduced pressure.

The process can be carried out, for example, as follows. The solid MXDT/ZT salt is prepared in, or alternatively charged to a reactor and heated to a set temperature in the range of 100-200° C., suitably around 130° C., to allow any water in the salt being removed by evaporation and being carried away via the purge gas, meanwhile keeping the temperature of the reactor wall and internals therein at the same temperature or above to avoid significant condensation on the surfaces. The solid MXDT/ZT salt is suitable staged at that set-temperature for as long as is necessary to remove the water in the salt. This may be checked, for example by means of a water trap. Once the water removal is complete, or nearly so, the solid MXDT/ZT salt is heated to a set point equal to Tc1. The first condensation sub-step may be tracked by the condensate formation rate, which starts slowly and then increases as the temperature rises. The prepolymer typically runs until the condensate collection rate drops significantly. The completeness of the conversion of the salt can also be checked with DSC by the absence of residual melting enthalpy reflecting the melting peak of the salt. For the second condensation sub-step the solid prepolymer formed may either be kept at the same temperature, i.e. Tc2 being equal to Tc1, or may be heated by to a set point equal to Tc2 and being higher than Tc1, but below the melting temperature of the polyamide produced in the first sub-step. The polyamide is kept at that temperature until the desired degree of polymerization is obtained. Once the polymerization is complete, the polymer is cooled and discharged from the reactor.

Rather than applying discrete sub-steps, the process may also be carried out by applying a temperature gradient going gradually to Tc1 and from Tc1 to Tc2. The heating may be done by applying a temperature ramp. The heating and cooling may be accomplished by heating the inert gas used for the purge, or by heating the reactor walls or internals therein, or any combination thereof.

The heating and cooling may be accomplished by heating the inert gas used for the purge, or by heating the reactor walls or internals therein, or any combination thereof.

Preferably the step (i), wherein the solid MXDT/ZT salt is provided, is a process wherein the MXDT/ZT salt is prepared by dosing of liquid diamines MXD and Z to an agitated powder of terephthalic acid. In this process, the salt-preparation (as well as the second step (ii)) in an agitated powder is typically carried out in absence of a liquid reaction medium, any solvent or dispensing agent, as is inherent with the conditions of the agitated powder. Step (i) is also carried out in absence of cryogenic cooling agent, as is inherent with the conditions of the dosing temperature being above melting temperature of the diamine. This does not exclude that during the process liquid components may be added or formed.

During the salt-preparation, also some water may be present in the starting materials or being formed during the dosing step. Small amounts of water are not a problem as long as it is possible to maintain a loose and flowable powder. The water can be removed later on during the heating in the first DSSP step.

The solid MXDT/ZT salt as provided in step (i) and used in step (ii) may comprise water, for example about 5 wt. %, while still remaining a flowable solid powder material. Preferably, the MXDT/ZT salt comprises at most 2.5 wt. % of water, more preferably at most 1 wt. % or even better at most 0.5 wt. % water, wherein the wt. % (weight percentage) is relative to the total weight of the salt including the water. In the DSSP process water has to be removed anyway, as water will be formed in the polycondensation reaction.

In the salt-preparation step, the diamines are dosed as a liquid at a dosing temperature above the melting temperature of the diamine mixture and below the melting temperature of the resulting salt and any intermediate products thereof.

For the salt preparation, the dosing temperature is preferably at least 40° C., more preferably at least 60° C. below the melting temperature of the salt (Tm-salt). Using a dosing temperature further below Tm-salt reduces the occurrence of premature reaction of the diamine and terephthalic acid.

The dosing temperature is also preferably between 35° C. and 200° C.

Using a lower dosing temperature reduces the problem of freed gaseous water being condensed in cold spots and scaling of powder on such spots.

The diamine is dosed to the agitated powder to form a powder reaction mixture meanwhile retaining an agitated powder. Thus, the diamine is preferably not added and mixed at once with the dicarboxylic acid in the agitated powder, as this could be incompatible with retaining an agitated powder, and could also lead to lumping of wetted parts and incomplete neutralization of non-wetted parts. This would severely complicate and even inhibit the proper mixing of the reacting components. The dosing rate is suitably limited to prevent local accumulation of liquid diamine, thereby preventing excessive wetting, local overheating and premature reaction with release of water resulting in excessive sticking and complicating moving of the bed.

The diamine is also suitably dosed with an average dosing rate between 0.05 mole % of diamine per minute (mppm) (corresponding with an overall dosing time of 33.3 hours) and 5 mole % (20 minutes) of diamine per minute (mppm), preferably between 0.1 mppm (16.7 hours) and 4 mppm (25 min), for example between 0.2 mppm (8.35 hours) and 2 mppm (50 min), or between 0.25 mppm (6.7 hours) and 1 mppm (100 minutes), wherein the mole % of diamine is relative to the molar amount of dicarboxylic acid. The times between brackets indicate the corresponding dosing time.

Long dosing times, respectively low dosing rates may be used, without a significant effect on the salt preparation itself, and will allow more time for the diamines to react with the terephthalic acid without creating softening or melting of the acid or solid MXDT/ZT salt, but might make the process less economical.

Short dosing times, respectively higher dosing rates may be used, where applicable, however, more energy is needed for good mechanical agitation of the terephthalic acid and the reaction mixture to achieving effective dispersion of the diamines in the reaction mixture and for removal of heat resulting from the neutralization reaction between the diamines and terephthalic acid, in order to prevent serious sticking and caking of the reaction mixture. The preferred dosing rate will depend on the manner that the motion in the agitated powder is accomplished, the flow properties of the powder, the way the liquid diamines are dispersed, the reaction components, reaction rate and the reaction conditions applied during dry-mixing. The fastest dosing rate in each individual case can be determined by routine experiments with varying dosing rates.

The MXDT/ZT salt does not necessarily have to be an equimolar salt. The MXDT/ZT salt may still contain some unreacted terephthalic acid, for example, if less than an equivalent amount of diamine was used. The salt may also contain some unreacted diamine, for example, if more than an equivalent amount of diamine was used. It has been observed that the MXDT/ZT salt may contain some excess diamine and still show the characteristics of a dry solid powder.

It has further been observed that in case of excess of diamines the molar balance is at least in part corrected during the first condensation sub-step, by evaporation of diamines, whereas in case of excess of terephthalic acid it is possible to correct the molar balance during the second condensation sub-step, by addition of diamines during that step. Therefore, the solid MXDT/ZT salt used in the processes according to the invention suitably has a diamine/terephthalic acid molar ratio in the range of 1.10-0.90, preferably 1.05-0.95, and more preferred 1.02-0.98.

The salt preparation step (i) can be carried out in different ways and different types of reactors. Suitably, the diamines and the terephthalic acid are contacted by spraying or dripping the diamines onto the agitated terephthalic acid powder. In a batch wise operation, suitably, the diamines and the terephthalic acid are contacted by spraying or dripping the diamine onto the agitated terephthalic acid powder consequently spraying the diamines onto the agitated mix of formed salt and terephthalic acid powder after addition of the diamines has started. Suitable reactors, in which the diamines and the terephthalic acid can be contacted and mixed, are, for example, tumble mixers, ploughshare mixers, conical mixers, planetary screw mixers and fluidized bed reactors. The said mixers are all low shear mixers. Further information on these and other low shear mixer apparatus can be found in the book “Handbook of Industrial Mixing—Science and Practice” edited by: Paul, Edward L.; Atiemo-Obeng, Victor A.; Kresta, Suzanne M. (Publisher: John Wiley & Sons; 2004; ISBN: 978-0-471-26919-9; Electronic ISBN: 978-1-60119-414-5), more particularly in Chapter 15, Part 15.4 and 15.11. For removal of neutralization heat produced upon reaction of the diamines and the terephthalic acid to form the MXDT/ZT salt a heat exchanger can be used.

The fact that the salt preparation step in the process according to the invention can be carried out without applying a high shear and still provide a high degree of conversion is highly surprising. In fact, the creation of an agitated powder can be accomplished with low shear agitation avoiding attrition of the terephthalic acid powder. In fact the attrition can be so low, or even absent at all, that the particle size distribution is hardly affected, apart from the fact that the size of the terephthalic acid powder particles might be even increased during the reaction with the diamine. The advantage of such low shear agitation without attrition of the terephthalic acid powder, is that amount of fines produced during the process is low, and that problems of fouling, dusting, sagging upon storage, and reduced flowability due to clogging of fines is reduced.

In a preferred embodiment of the process according to invention, the terephthalic acid powder used therein comprises a low amount of particles with small particle size. Also preferred is a terephthalic acid powder having a narrow particle size distribution. The advantage thereof is that also the resulting MXDT/ZT salt so produced also has less small particles, respectively a relative narrow particle size distribution, and optionally even better flow properties. Suitably, the use of terephthalic acid powder with low amount of small particles and/or narrow particle size distribution is combined with low shear agitation.

The salt preparation step in the process according to the invention is suitably carried out in an inert gas atmosphere. For the inert gas atmosphere, suitable gases as generally known as generally known in the art for the polymerization of polyamides can be used. Such inert gas is typically oxygen-free or essentially so, and free of other oxidative reactive gasses such as O3, HNO3, HClO4 etc. Suitably, nitrogen gas is used as the inert gas. The salt preparation as well as the polymerization steps are suitably carried out at atmospheric pressure, or at a slight overpressure, for example in the range from 1 to 5 bar, for example at about 1.5 bar, or 2 or 3 bar. Using an overpressure has the advantage that diamine losses during salt preparation are reduced, if occurring at all.

The PA-MXDT/ZT polymers with an increased glass transition temperature (Tg) are new in the state of the art. The Tg of the polyamides made according to the process of the invention depends on the number of CH₂ groups present in MXD and Z.

The invention therefore relates to a PA-MXDT/ZT polyamide, wherein MXD is meta-xylylenediamine, T is terephthalic acid, Z is a linear aliphatic diamine having from 2 to 12 carbon atoms, Z is from 0 to 40 mole % with respect to the total of MXD and Z units in the copolymer and the polymer has a glass transition temperature Tg fulfilling the following relation: Tg>226−475*Y, wherein Y is the weight ratio (g/g) of all CH₂ groups in the polyamide with respect to the weight of the total weight of the polyamide. In the context of the invention, Y is at most 0.15 and at least 0.105. Herein Tg is measured according ISO 11357-1/2 in the second heating after a first heating/cooling cycle, wherein the polyamide is heated with 20° C./min to 350° C. and immediately cooled with 20° C./min to 0° C. The second heating is carried out with a scan rate of 20° C./min to 350° C.

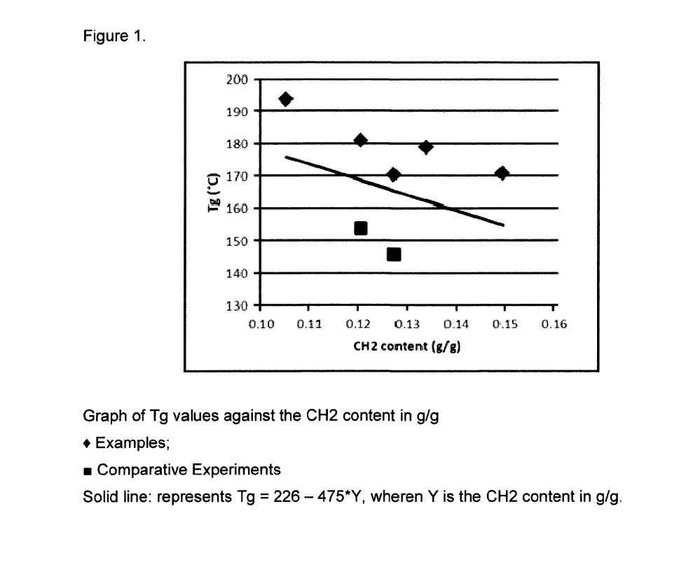

FIG. 1 shows a graph, wherein Tg is shown against the CH₂ content in g/g for examples according to the invention (diamond symbol ♦) and Comparative Experiments (square synmbol ▪), and a solid line representing the formula Tg=226−475*Y, wherein Y is the CH₂ content in g/g.

Another advantage of the process of the invention is that less side reactions and degradation occur with respect to polymers made by the process described in US2009/0012229 A1. Suitably, the polyamide of the invention has a viscosity number of at least 20 ml/g, preferably at least 35 ml/g, more preferred at least 50 ml/g, or even at least 65 ml/g. The viscosity number is herein measured in 96% sulphuric acid (0.005 g/ml) at 25° C. by the method according to ISO 307, fourth edition.

In the polyamide of the invention Z is a linear aliphatic diamine having from 2 to 12 carbon atoms. Preferably Z is 1,4-diaminobutane, 1,5-aminopentane, 1,6-diaminohexane, or a combination thereof. Accordingly, Z can be one linear aliphatic diamine, or a combination of more than one linear aliphatic diamines. if Z is the combination of more than one diamines, the copolymer which is the object of the present invention can be designated as MXDT/Z¹T/Z²T or MXDT/Z¹T/Z²T/Z³T. Preferably the mixture of diamines is selected from the group consisting of 1,4-diaminobutane, 1,5-diaminopentane and hexamethylenediamine.

The PA-MXDT/ZT polyamides with a high Tg are new in the state of the art, as well as the surprising fact that the DSSP process could be used for the production of these transparent copolymers. Even more surprising was the fact that the copolymers with an amount of Z is from 5 to 40 mole % have a melting point in the first DSC heating cycle with a melting enthalpy of at least 25 J/g, preferably at least 40 J/g, most preferably at least 50 J/g. A higher melting enthalpy leads to a lower risk of reactor fouling or powder agglomeration during the polymerization.

In a second heating by means of DSC, the copolymers show a low melting enthalpy, typically being lower than 25 J/g, or even below 20 J/g. The advantage of a lower melting enthalpy in the second heating is that the materials are more transparent in injection moulding or extrusion applications.

The invention therefore also relates to a new class of polyamide copolymers wherein the copolymers according to the invention have a melting point in the first DSC heating cycle with a melting enthalpy of at least 25 J/g.

In a particular embodiment of the invention, the polyamide is an PA-MXDT homopolymer, i.e. The new PA-MXDT homopolymer has a Tg of at least 176° C. Herein the glass transition temperature (Tg) is measured by DSC with a scan rate of 20° C./min in the second heating cycle after heating to 350° C. and direct cooling and determined by the method according to ISO 11357-1/2. The advantage is that the polymer retains its mechanical and barrier properties, such as stiffness, up to higher temperatures.

In another particular embodiment of the invention, the polyamide is an PA-MXDT/ZT comopolymer with a Tg of at least 156° C., fulfilling the following relation: Tg>195-240·Y, wherein Y is the weight ratio (g/g) of all CH₂ and wherein the Tg is measured as recited above.

The invention is further related to a moulding composition comprising the polyamide of the invention. Moulding compositions may comprise fillers like fibrous reinforcing materials, impact modifiers, like elastomers and other additives or processing aids.

Preferred fibrous reinforcing materials are carbon fibers, potassium titanate whiskers, aramid fibers, and particularly preferably glass fibers. If glass fibers are used, these may have been equipped with a coupling agent and with a size to improve compatibility with the thermoplastic polyamide. Suitable particulate fillers are amorphous silica, magnesium carbonate (chalk), kaolin (in particular calcined kaolin), powdered quartz, mica, talc, feldspar, and in particular calcium-silicates, such as wollastonite.

Preferred elastomers are those known as ethylenepropylene (EPM) and ethylene-propylene-diene (EPDM) rubbers. EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Examples of conventional additives are stabilizers and oxidation retarders, agents to counteract thermal decomposition and decomposition via ultraviolet light, lubricants and mold-release agents, dyes, pigments, and plasticizers.

### Viscosity Number (VN)

The viscosity number (VN) was measured according to ISO 307, fourth edition. For the measurement a pre-dried polymer sample was used, the drying of which was performed under high vacuum (i.e. less than 50 mbar) at 80° C. during 24 hrs. Determination of the viscosity number was done at a concentration of 0.5 gram of polymer in 100 ml of sulphuric acid 96.00±0.15% m/m at 25.00±0.05° C. The flow time of the solution (t) and the solvent (to) were measured using a DIN-Ubbelohde from Schott (ref. no. 53020) at 25° C. The VN is defined as

$$VN = \frac{( \frac{t}{{t}_{0}} - 1 )}{c} = ( \frac{t}{{t}_{0}} - 1 ) * 200$$

wherein:
VN=viscosity number, in ml/g
t=average flow time of the sample solution, in seconds
t₀=average flow time of the solvent, in seconds
c=concentration, in g/ml (=0.005)

### Determination of the Melting Temperature (Tm) of Both the Salt as Well as the Polymer, the Glass Transition Temperature (Tg) and the Melting Enthalpy (ΔHm) by Means of DSC.

With the term melting temperature (Tm) is herein understood the temperature, measured by the DSC method according to ISO-11357-1/3, 2009, in an N2 atmosphere with a heating and cooling rate of 20° C./min. Herein Tm1, Tm2 is determined from the peak value of the highest melting peak in the first heating cycle, respectively second heating cycle after heating to 350° C. and direct cooling.

With the term melting enthalpy, is herein understood the enthalpy (ΔHm), measured by the DSC method according to ISO-11357-1/3, 2009, in an N2 atmosphere with a heating and cooling rate of 20° C./min. Herein ΔHm1, ΔHm2 is determined in the first heating cycle, respectively in the second heating cycle after heating to 350° C. and direct cooling.

For the glass transition temperature, Tg, determination was according to ISO 11357-1/2. The second heating cycle was used after heating with the above mentioned scan rate of 20° C./min.

For the measurements a standard heat flux Mettler-Toledo DSC 823 was used and the following conditions applied. Samples of approximately 3 to 10 mg mass were weighed with a precision balance and encapsulated in (crimped) 40 μl aluminium crucibles of known mass. The aluminium crucible was sealed with a perforated aluminium crucible lid. The perforation was mechanically performed and consisted of a hole width of 50 μm. An identical empty crucible was used as a reference. Nitrogen was purged at a rate of 50 ml min⁻¹. Heating-cooling-heating cycles with scan rates of 20° C./min, in the range of 0 to 350° C. were applied for determining the parameters that numerically characterize the thermal behaviour of the investigated polymers.

### Determination of End Group Concentrations and of CH₂ Ratio (Y) by ¹H NMR

PA-MXDT/ZT is dissolved in 5 mm NMR tube in H₂SO₄. 5 mm NMR tube is placed in 10 mm NMR tube containing CDCl₃. The acquired ¹H NMR spectrum is referenced to the chloroform resonance (7.24 ppm). The concentrations of the end groups are determined by integration of the corresponding proton signals and corrected for the number of protons as follows:

$$concentration of MXD end groups [ \frac{mmol}{kg} ] = \frac{Area ( peak 1 )}{2 \cdot SUM} * 1000 \\ concentration of diamine Z end groups [ \frac{mmol}{kg} ] = \frac{Area ( peak 2 )}{2 \cdot SUM} * 1000$$

$$concentration of TPA end groups [ \frac{mmol}{kg} ] = \frac{Area ( peak 3 )}{2 \cdot SUM} * 1000$$

where area (peak 1) is the integral of the peak at a shift of 4.17 ppm, area (peak 2) is the integral of the peak at a shift of 3.04 ppm and area (peak 3) is the integral of the peak at a shift of 8.23 ppm; and SUM is the total amount of polyamide determined by the sum of all the different units composing the polyamide according to the following equation:

$$SUM = \frac{Area ( peak 1 ) * 135}{2} + \frac{Area ( peak 2 ) * ( {MW}_{diamine Z} - 1 )}{2} + \frac{Area ( peak 3 ) * 149}{2} + \frac{Area ( peak 4 ) * 134}{4} + \frac{Area ( peak 5 ) * ( {MW}_{diamine Z} - 2 )}{4} + \frac{[ Area ( peak 6 ) - Area ( peak 7 ) ] * 132}{4}$$

where area (peak 4) is the integral of the peak at a shift of 4.79 ppm (incorporated MXD), area (peak 5) is the integral of the peak at a shift of 3.70 ppm (incorporated diamine Z), area (peak 6) is the integral of the peak at a shift of 7.89 ppm (incorporated TPA) and area (peak 7) is the integral of the peak at a shift of 8.23 ppm; and MW_{diamine z} is the molecular weight of the diamine Z.
The concentration of amine end groups is the sum of the concentration of MXD end groups and the concentration of diamine Z end groups.
The weight ratio (g/g) Y of all CH₂ groups in the polyamide with respect to the total weight of the polyamide is determined with the following equation:

$$Y = \frac{[ Area ( peak 4 ) + ( Area ( peak 5 ) * ( \frac{cnst 1}{2} ) ) ] * \frac{28}{4}}{SUM}$$

Where cnst1 is the number of CH₂ groups in the diamine Z, wherein if more than one diamine is present, cnst1 is the molar average number of CH₂ groups present in the diamine and wherein Area(peak 4), Area(peak 5) and SUM are as defined above.

### Raw Materials

Terephthalic acid: powder, industrial grade, melting temperature above 400° C.
1,4-Diaminobutane industrial grade; max 1 wt. % water, impurities in ppm range; melting temperature 27.5° C.
Hexamethylene diamine industrial grade max 1 wt. % water, impurities in ppm range; melting temperature 41° C.
Meta-xylylene diamine industrial grade; max 1 wt. % water, impurities in ppm range; melting temperature 14° C.

### EXPERIMENTS

### S1. Preparation: MXDT/4T Salt

223.35 g (1.344 mol) of solid terephthalic acid powder was charged into a 2 litre baffled flask. The flask was attached to a rotary evaporator equipped with a heated diamine dosing vessel, inertized by purging with 5 gram per hour nitrogen gas for 1 hour. The content in the flask was mixed by rotation of the flask at 60 rpm and kept under nitrogen atmosphere (5 gram per hour). The rotating flask was partially submerged in an oil bath maintained at 65° C., thereby allowing the powder to reach the same temperature. A liquid mixture of 13.85 g (0.157 mole) 1,4-diaminobutane and 164.8 g (1.21 mole) of MXD was prepared by melting and mixing the diamines at room temperature and heated in a dosing vessel to 65° C. Then, the liquid mixture was added drop-wise to the acid powder at a dosing rate of 0.5 g ml/minute under constant rotation. After completion of the dosing, the reaction mixture was stirred by rotation while keeping the flask in the oil bath at a temperature of 65° C. for another 120 minutes. Then the flask was cooled to room temperature and the salt was discharged from the flask. The salt so obtained was a free flowing powder. The melting point was 284° C.

### S2. Preparation: MXDT/4T Salt

Example S1 was repeated except that 227.02 g (1.344 mole) of solid terephthalic acid powder was charged into the baffled flask and a mixture of 148.9 g (1.093 mol) MXD and 26.1 g (0.296 mole) 1,4-diaminobutane was added at a rate of 0.5 ml/min. The salt so obtained was a free flowing powder; melting point 283° C.

### S3. Salt Preparation: MXDT Salt

A 250 ml three necked flask, equipped with a reflux condenser, a temperature sensor and a magnetic stirring rod was charged with 150 ml water and 22.52 g MXD. Over 1 minute 27.46 g terephthalic acid is added via a 2 cm necked funnel attached to the third neck. This led to a temperature rise from 23 to 32° C., while vigorously stirring. In course of the PTA addition, the MXDT salt forms as a white insoluble slurry. The reaction mixture was heated to reflux temperature (102° C.) for 1 hour at which temperature the slurry was not yet dissolved, before allowing to cool. The cooled slurry was filtered over with a Büchner funnel and the filter cake washed with 50 ml acetone. The product was dried by allowing air to pass through the filter cake for 3 hours. The product had a melting point of 292° C., determined by DSC.

### POLYMERIZATION EXPERIMENTS

Polymerization was performed in a Mettler-Toledo TGA/DSC instrument. Approximately 3 to 10 mg mass were weighed with a precision balance and encapsulated in (crimped) 40 μl aluminium crucibles of known mass. The aluminium crucible was sealed with a perforated aluminium crucible lid. The perforation was mechanically performed. An identical empty crucible was used as a reference. Nitrogen was purged at a rate of 50 ml/min. Heating occurred with a rate of 1° C./min from room temperature to a maximum temperature, followed by an isothermal period.

### Comparative Experiment C1

### Copolyamide PA-MXDT/4T

7.64 mg of the salt of Exp S1 (MXDT/4T) was heated in a 0.04 ml aluminum reactor with a lid having a 1 mm hole to allow for condensates to leave the reactor. It is heated in an inert atmosphere to 260° C. at 20° C./min and kept at 260° C. for 3 hours. The polymer was obtained as a powder. Results are shown in Table 1.

### Example E1

### Copolyamide PA-MXDT/4T

7.02 mg of the salt of powder of Example S1 was heated in a 0.05 ml aluminum reactor with a lid having a 0.05 mm hole to allow for condensates to leave the reactor. It is heated in an inert atmosphere to 260° C. at 20° C./min and kept at 260° C. for 3 hours. The polymer was obtained as a powder. Results are shown in Table 1.

### Example E2

### Copolyamide PA-MXDT/4T

6.6 mg of the salt of the salt powder of Example S1 together with 0.4 mg MXD was heated in a 0.05 ml aluminum reactor with a lid having a 0.05 mm hole to allow for condensates to leave the reactor. It is heated in an inert atmosphere to 260° C. at 20° C./min and kept there for 3 hours. The polymer was obtained as a powder.

### Comparative Experiment C2

### Copolyamide PA-MXDT/4T

Example E2 was repeated except that 6.45 mg of the salt powder of Example S1 together with 6.45 mg MXD was used as starting materials. The polymer was obtained as a powder.

### Example E3

### Copolyamide PA-MXDT/4T

Example E1 was repeated except that 7.05 mg of the salt powder of Example S2 was used. The polymer was obtained as a powder.

### Example E4

### Copolyamide PA-MXDT/4T

Example E2 was repeated except that 8.59 mg of the salt powder of Example S2 together with 0.77 mg MXD was used. The polymer was obtained as a powder.

### Example E5

### Polyamide PA-MXDT in a Stirred Reactor

The polymerization was carried out in a double walled 1 liter electrically heated metal reactor equipped with a helically shaped stirring unit, an inert gas inlet and an exit for the inert gas and the condensate gas to leave the reactor, and thermometers to measure the temperature of the reactor wall and the reactor content. The reactor was charged with salt powder. The salt powder was stirred and a nitrogen gas purge of 5 gram per hour was applied to inertize the reactor content. Then the reactor content was heated by heating the reactor wall applying a programmed temperature profile and monitoring the temperature of the reactor content in the powder bed, meanwhile continuing the nitrogen gas purge and stirring of the reactor content.

300 g of the salt of Example S3 was used. The nitrogen gas purge was set and kept at 5 gram per hour gas volume at room temperature. The reactor content was inertized during 3 hours, before starting the heating profile. The reactor content was heated from 25 to 220° C. in 2 hrs, kept at 220° C. for 3 hours, heated to 235° C. in 5 hours, heated to 265° C. in 1.5 hours, and then heated to 275° C. Then the nitrogen purge was stopped. Then 15 g of MXD was dosed to the closed reactor over 60 minutes, after which the nitrogen purge was opened again at 5 gram per hour and the temperature kept for two more hours at 275° C., Then the reactor content was cooled to <100° C. in 2 hrs which resulted in a free flowing polymer. Yield 260 g. The product had a solution viscosity (ISO 307) VN of 43.5 ml/g.

TABLE 1
Glass transition values, CH₂ contents, melting points Tm1 and
Tm2 and their characteristic melt enthalpies of polyamides obtained

| | | | Tg | Tm1 | ΔHm1 | Tm2 | ΔHm2 |
|---|---|---|---|---|---|---|---|
| | | | [° C.] | [° C.] | [J/g] | [° C.] | [J/g] |
| | | | 2nd | 1st | 1st | 2nd | 2nd |
| | | | heating | heating | heating | heating | heating |
| | | CH₂ | to | to | to | to | to |
| | Composition | content | 350° C. | 350° C. | 350° C. | 350° C. | 350° C. |
| C1 | MXDT/4T | 0.1271 | 146 | 306 | 11 | 325 | 10 |
| El | MXDT/4T | 0.1271 | 170.5 | 320/ | 64 | 330 | 22 |
| | | | | 336 a) | | | |
| E2 | MXDT/4T | 0.1205 | 181 | 326 | 66 | 333 | 7 |
| C2 | MXDT/4T | 0.1205 | 154 | 310 | 29 | No | — |
| | | | | | | peak | |
| E3 | MXDT/4T | 0.1494 | 171 | 318 | 60 | 334 | 15 |
| E4 | MXDT/4T | 0.1338 | 179 | 292 | 60 | — | — |
| E5 | MXDT | 0.1051 | 194 | 311/ | 72 | 318 | 52 |
| | | | | 340 a) | | | |

a) Double melting peak observed
The numbers behind Tg and Tm refer to whether they are determined in the first
heating (1) or in the second heating (2)

1. Process for the production of a PA-MXDT/ZT polyamide comprising the following steps:
i. providing a solid MXDT/ZT salt, wherein MXD is meta-xylylenediamine, T is terephthalic acid, Z is a linear aliphatic diamine having from 2 to 12 carbon atoms and wherein the amount of Z is from 0 to 40 mole % with respect to the total of the amount of MXD and Z units in the polymer;
ii. solid state polymerizing the MXDT/ZT salt to obtain the polyamide, wherein the solid state polymerization is carried out at least partly under a diamine atmosphere.

2. Process according to claim 1, wherein the MXDT/ZT salt is prepared by dosing of liquid diamines MXD and optionally Z to an agitated powder of terephthalic acid.

3. Process according to claim 1, wherein the MXDT/ZT salt is prepared from diamines MXD and optionally Z in an aqueous solution.

4. Process according to claim 1, wherein the diamines MXD and Z are dosed at a dosing speed of at most 4 mole % diamine per minute, relative to the molar amount of the terephthalic acid.

5. Process according to claim 1, wherein the diamine/terephthalic acid molar ratio in the solid MXDT/ZT salt is in the range of 1.10-0.90.

6. PA-MXDT/ZT polyamide polymer, wherein MXD is meta-xylylenediamine, T is terephthalic acid, Z is a linear aliphatic diamine having from 2 to 12 carbon atoms, Z is from 0 to 40 mole % with respect to the total of MXD and Z units in the polymer and the polymer has a glass transition temperature (Tg, in ° C.) fulfilling the following relation: Tg>226−475*Y, wherein Y is the weight ratio (g/g) of all CH₂ groups in the polyamide measured by ¹H-NMR in a D₂SO₄ solution, with respect to the total weight of the polyamide, wherein the Tg is measured by DSC with a scan rate of 20° C./min in the second heating cycle after heating to 350° C. and direct cooling and determined by the method according to ISO 11357-1/2, wherein Y is at most 0.15.

7. Polymer according to claim 6, wherein Z is selected from the group consisting of 1,4-diaminobutane, 1,5-diaminopentane, 1,6-diaminohexane.

8. PA-MXDT/Z′T/Z²T polyamide copolymer, wherein MXD is meta-xylylenediamine, T is terephthalic acid, Z¹ and Z² are diamines selected from the group consisting of 1,4-diaminobutane, 1,5-diaminopentane, and hexamethylenediamine, and are present in an amount ranging from 5 to 40 mole % with respect to the total of MXD and Z units in the copolymer and the copolymer has a glass transition temperature (Tg, in ° C.) fulfilling the following relation: Tg>226−475*Y, wherein Y is the weight ratio (g/g) of all CH₂ groups in the polyamide measured by ¹H-NMR in a D₂SO₄ solution, with respect to the total weight of the polyamide, wherein the Tg is measured by DSC with a scan rate of 20° C./min in the second heating cycle after heating to 350° C. and direct cooling and determined by the method according to ISO 11357-1/2, wherein Y is at most 0.15.

9. PA-MXDT/Z1T/Z2T/Z3T polyamide copolymer, MXD is meta-xylylenediamine, T is terephthalic acid, Z1, Z2 and Z3 are 1,4-diaminobutane, 1,5-diaminopentane, and hexamethylenediamine, and are present in an amount ranging from 5 to 40 mole % with respect to the total of MXD and Z units in the copolymer and the copolymer has a glass transition temperature (Tg, in ° C.) fulfilling the following relation: Tg>226−475*Y, wherein Y is the weight ratio (g/g) of all CH₂ groups in the polyamide measured by ¹H-NMR in a D₂SO₄ solution, with respect to the total weight of the polyamide, wherein the Tg is measured by DSC with a scan rate of 20° C./min in the second heating cycle after heating to 350° C. and direct cooling and determined by the method according to ISO 11357-1/2, wherein Y is at most 0.15.

10. Polymer according to claim 6, wherein the polymer has a viscosity number of at least 40 ml/g, measured in 96% sulphuric acid (0.005 g/ml) at 25° C. by the method according to ISO 307, fourth edition.

11. Polymer according to claim 6, wherein the polymer has a melting enthalpy in the first heating cycle of at least 40 J/g, measured by DSC with a scan rate of 20° C./min determined by the method according to ISO 11357-1/3.

12. Moulding composition comprising the polymer of claim 6.
